(19) United States
(12) Patent Application Publication
(10) Pub. No.: US 2014/0258001 A1
(43) Pub. Date: Sep. 11, 2014

(54) Systems and Methods for Determining Net-New Keywords in Expanding Live Advertising Campaigns in Targeted Advertising Systems

(71) Applicant: DATAPOP, INC., Los Angeles, CA (US)

(72) Inventors: Cartic Ramaksrihnan, Los Angeles, CA (US); John Zimmerman, Los Angeles, CA (US); Behzad Zamanzaden, Tarzana, CA (US); John Warden, Los Angeles, CA (US); Oleg Kozlov, Los Angeles, CA (US)

(73) Assignee: DataPop, Inc., Los Angeles, CA (US)

(21) Appl. No.: 13/791,423

(22) Filed: Mar. 8, 2013

(51) Int. Cl. G06Q 30/02

(52) U.S. Cl. CPC G06Q 30/0276
USPC 705/14.72

(57) ABSTRACT

Systems and methods for creating expanded targeted search advertising campaigns in accordance with embodiments of the invention are disclosed. In one embodiment, a campaign expansion device includes a processor and a campaign expansion application, wherein the campaign expansion application configures the processor to obtain a live advertising campaign, where the live advertising campaign includes a plurality of keywords and match types associated with the keywords, determine at least one centroid cluster including a portion of the plurality of keywords, identify at least one target centroid cluster in the at least one centroid cluster, modify at least one match type associated with at least keyword, and generate an expanded advertising campaign, where the extended advertising campaign includes the unmodified portion of the plurality of keywords and match types associated with the keywords from the live advertising campaign and the modified keywords and associated match types.

### FIELD OF THE INVENTION

The present invention relates to targeted search advertising and more specifically to the determination of keywords and creatives for use expanding targeted advertising campaigns utilized in targeted advertising systems.

### BACKGROUND

The term e-commerce is used to refer to the buying and selling of products or services over electronic systems such as the Internet and other computer networks. The amount of trade conducted via e-commerce has grown extraordinarily with widespread Internet usage. As a result, a variety of websites have been established to offer goods and services.

Search engines are useful tools for locating specific pages of information on the World Wide Web and are increasingly used to locate goods and services. As a result, many websites use search advertising/search engine marketing to attract visitors to product, service, and/or category landing pages. Search advertising describes the placement of online advertisements adjacent or amongst the search results returned by a search engine in response to a specific search query. Search engine marketing typically involves paying for a specific online advertisement or creative to be featured in or adjacent to the search results provided in response to a specific query. Typically, the position of an advertisement within the returned search results is a function of the bid scaled by a quality factor that measures the relevance of the creative and landing page combination to the search query. Accordingly, the provider of the search engine is incentivized to feature relevant keyword/advertisement/landing page combinations so that users will select featured advertisements and increase the revenue generated by the search engine provider. In the context of paid search advertising, the term keyword refers to both a single word and a specific combination of words or keyword components.

When a website includes a large number of products or services, the process of building and managing a paid search advertising campaign can be quite complex. Many search engines provide the ability to upload an entire advertising campaign including one or more creatives that target a set of keywords, and associated bids to be used when the display of the creative is triggered by specific keywords. For example, Google, Inc. of Mountain View, Calif., defines an Ad Group file format that enables advertisers to upload paid search advertising campaigns.

Leading search engine providers offer a variety of different match types when building a paid search advertising campaign. Keyword match options or match types specify the similarity required between a keyword in a search query and a keyword specified in a paid search advertising campaign in order to trigger the display of a creative. Google, Inc. provides four different match types. “Broad match” matches keywords to similar phrases and relevant variations in a search query. “Modified Broad Match” is similar to “broad match,” but with the restriction that at least one specified keyword component or a close variant match exactly within the search query. “Phrase match” means that the keyword be present within the query exactly. “Exact match” requires that the keyword or a close variant and the search query match. In addition to the four match types, “negative matches” can also be specified to prevent a creative from being displayed when a specific keyword is present.

### SUMMARY OF THE INVENTION

Systems and methods for creating expanded targeted search advertising campaigns based upon a live advertising campaign in accordance with embodiments of the invention are disclosed. In one embodiment, a campaign expansion device includes a processor and a memory connected to the processor and configured to store a campaign expansion application, wherein the campaign expansion application configures the processor to obtain a live advertising campaign, where the live advertising campaign includes a plurality of keywords and match types associated with the keywords, determine at least one centroid cluster including a portion of the plurality of keywords in the live advertising campaign, where the included portion of the plurality of keywords in a centroid cluster are related, identify at least one target centroid cluster in the at least one centroid cluster, modify at least one match type associated with at least keyword within each of the identified target centroid clusters, and generate an expanded advertising campaign, where the extended advertising campaign includes the unmodified portion of the plurality of keywords and match types associated with the keywords from the live advertising campaign and the modified keywords and associated match types.

In another embodiment of the invention, the campaign expansion application further configures the processor to deploy the expanded advertising campaign to a device selected from the group consisting of an advertising server system and a search engine provider.

In an additional embodiment of the invention, the campaign expansion application further configures the processor to add at least one keyword having an associated match type to at least one of the identified centroid clusters.

In yet another additional embodiment of the invention, the added keyword has a match type selected from the group consisting of an exact match type and a phrase match type.

In still another additional embodiment of the invention, the campaign expansion application further configures the processor to identify keywords as related using a semantic model, where the semantic model includes a set of relationships between keywords and concepts defined by categories and attributes.

In yet still another additional embodiment of the invention, the campaign expansion application further configures the processor to identify keywords as related based on the distance between the keywords within the semantic model.

In yet another embodiment of the invention, the campaign expansion application further configures the processor to identify keywords as related based on the match types associated with the keywords.

In still another embodiment of the invention, the campaign expansion application further configures the processor to identify at least one target centroid cluster based on the performance of the keywords associated with the target centroid cluster.

In yet still additional embodiment of the invention, the campaign expansion application further configures the processor to determine the identified target centroid cluster with the highest performance and exclude the identified target centroid cluster with the highest performance from being modified.

In yet another additional embodiment of the invention, the campaign expansion application further configures the processor to identify a portion of the keywords in the live advertising campaign that are not associated with a centroid cluster, create a miscellaneous centroid cluster including the portion of the keywords in the live advertising campaign that are not associated with a centroid cluster, and include the miscellaneous centroid cluster in the extended advertising campaign.

Still another embodiment of the invention includes a method for creating an expanded advertising campaign including obtaining a live advertising campaign using a campaign expansion device, where the live advertising campaign includes a plurality of keywords and match types associated with the keywords, determining at least one centroid cluster including a portion of the plurality of keywords in the live advertising campaign using the campaign expansion device, where the included portion of the plurality of keywords in a centroid cluster are related, identifying at least one target centroid cluster in the at least one centroid cluster using the campaign expansion device, modifying at least one match type associated with at least keyword within each of the identified target centroid clusters using the campaign expansion device, and generating an expanded advertising campaign using the campaign expansion device, where the extended advertising campaign includes the unmodified portion of the plurality of keywords and match types associated with the keywords from the live advertising campaign and the modified keywords and associated match types.

In yet another additional embodiment of the invention, creating an expanded advertising campaign further includes deploying the expanded advertising campaign to a device using the campaign expansion device, where the device is selected from the group consisting of an advertising server system and a search engine provider.

In still another additional embodiment of the invention, creating an expanded advertising campaign further includes adding at least one keyword having an associated match type to at least one of the identified centroid clusters using the campaign expansion device.

In yet still another additional embodiment of the invention, the added keyword has a match type selected from the group consisting of an exact match type and a phrase match type.

In yet another embodiment of the invention, creating an expanded advertising campaign further includes identifying keywords as related based on semantic model using the campaign expansion device, where the semantic model includes a set of relationships between keywords and concepts defined by categories and attributes.

In still another embodiment of the invention, creating an expanded advertising campaign further includes identifying keywords as related based on the distance between the keywords within the semantic model using the campaign expansion device.

In yet still another embodiment of the invention, creating an expanded advertising campaign further includes identifying keywords as related based on the match types associated with the keywords using the campaign expansion device.

In yet another additional embodiment of the invention, creating an expanded advertising campaign further includes identifying at least one target centroid cluster based on the performance of the keywords associated with the target centroid cluster using the campaign expansion device.

In still another additional embodiment of the invention, creating an expanded advertising campaign further includes determining the identified target centroid cluster with the highest performance using the campaign expansion device and excluding the identified target centroid cluster with the highest performance from being modified using the campaign expansion device.

In yet still another additional embodiment of the invention, creating an expanded advertising campaign further includes identifying a portion of the keywords in the live advertising campaign that are not associated with a centroid cluster using the campaign expansion device, creating a miscellaneous centroid cluster including the portion of the keywords in the live advertising campaign that are not associated with a centroid cluster using the campaign expansion device, and including the miscellaneous centroid cluster in the extended advertising campaign using the campaign expansion device.

### BRIEF DESCRIPTION OF THE DRAWINGS

FIG. 1 is a conceptual illustration of a targeted advertising system in accordance with an embodiment of the invention.

FIG. 2 is a flow chart illustrating a process for determining net-new keywords for an expanded bulksheet in accordance with an embodiment of the invention.

FIG. 3 is a flow chart illustrating a process for determining net-new exact keywords in accordance with an embodiment of the invention.

FIG. 4 is a flow chart illustrating a process for determining net-new phrase keywords in accordance with an embodiment of the invention.

FIG. 5 is a flow chart illustrating a process for determining net-new broad keywords in accordance with an embodiment of the invention.

FIG. 6 is a conceptual illustration of an expanded advertising campaign created by applying an expanded bulksheet to a live advertising campaign in accordance with an embodiment of the invention.

FIG. 7 is a flow chart illustrating a process for generating and analyzing the performance of an expanded advertising campaign based upon a live advertising campaign in accordance with an embodiment of the invention.

FIG. 8 is a flow chart illustrating a process for modifying a targeted advertising campaign utilizing centroid clusters in accordance with an embodiment of the invention.

### DETAILED DESCRIPTION

Turning now to the drawings, systems and methods for creating expanded targeted search advertising campaigns based upon a live advertising campaign with the perseveration of keywords and creatives present in the live advertising campaign in accordance with embodiments of the invention are disclosed. Campaign expansion devices in accordance with embodiments of the invention are configured to generate expanded advertising campaigns based on a live advertising campaign. The term live advertising campaign is used to describe an advertising campaign that is currently running on an advertising campaign system and/or a search engine provider. Other advertising campaigns can be considered live advertising campaigns as appropriate to the requirements of specific applications in accordance with embodiments of the invention. A variety of advertising campaign systems can be utilized in accordance with embodiments of the invention to create targeted advertising campaigns and to modify keywords and creatives utilized in the targeted advertising campaign. Systems and methods for creating targeted advertising campaigns that can be utilized in accordance with embodiments of the invention are disclosed in U.S. patent application Ser. No. 13/424,373, titled “Taxonomy Based Targeted Search Advertising” to Zimmerman et al., filed Mar. 19, 2012, the entirety of which is incorporated by reference. Modifications to keywords and creatives are utilized to expand the advertising targets of the advertising campaign, expand the number of keywords targeted by the advertising campaign, and/or to improve the overall effectiveness of the advertising campaign. However, these modifications can be problematic with some existing targeted advertising campaigns where there is a desire to preserve optimizations already performed in the live advertising campaign. This issue is particularly relevant in those targeted advertising campaigns in which search marketers have performed optimization of the keywords present in the existing targeting advertising campaign.

An expanded advertising campaign generated using a campaign expansion device modifies existing keywords and creatives present in a live advertising campaign and/or adds additional keywords and creatives to the live advertising campaign with the goal of targeting additional advertising targets and/or better targeting existing advertising targets. An expanded advertising campaign can be run alongside a live advertising campaign and/or the expanded campaign can replace a live advertising campaign in one or more markets. If some or all of the modifications present in the expanded advertising campaign exhibit improved performance relative to the live advertising campaign, can be integrated into the live advertising campaign. A variety of testing methodologies can be utilized to determine if the modified and/or additional keywords and creatives present in the expanded advertising campaign exhibit improved performance by the expanded advertising campaign in accordance with embodiments of the invention. These testing methodologies include, but are not limited to, performing NB testing using the live advertising campaign and the expanded advertising campaign. Other testing methodologies can be utilized in accordance with a variety of embodiments of the invention.

Systems in accordance with embodiments of the invention automatically generate expanded search advertising campaigns containing net-new keywords and/or creatives. In many embodiments of the invention, net-new keywords are reconciled with the match type of keywords currently present in the live advertising campaign. The term net-new keywords is used to refer to keywords that are not present in an existing live advertising campaign, which are added to an expanded advertising campaign based on the existing live advertising campaign. Once a set of net-new keywords is determined, the keywords in the set of net-new keywords can be utilized in a targeted search advertising system in order to expand an existing live advertising campaign. Systems in accordance with embodiments of the invention are also configured to adjust the match type of keywords present in the live advertising campaign. By adjusting the match type of existing keywords and adding new keywords with the appropriate match types, a live advertising campaign can be improved upon by better targeting keywords to search terms.

In a variety of embodiments, semantic models are utilized to determine centroid clusters based on the keywords in the live campaign. Centroid clusters include one or more keywords and/or concepts that are related in a manner such that the keywords and/or concepts in the centroid cluster conceptually form an ad group. In accordance with embodiments of the invention, relationships between keywords and/or concepts are based upon the relationship(s) between the keywords and/or concepts within a semantic model. In several embodiments, campaign expansion systems are configured to identify one or more centroid clusters within a live advertising campaign and generate an expanded advertising campaign by modifying the live campaign on a centroid cluster by centroid cluster basis.

The term semantic model is used to describe a particular scheme for classifying products and/or services. Collectively products and/or services (indeed any object, person, idea, or action) can be referred to as a concept and, in many embodiments, concepts can be defined in terms of categories and attribute value pairs. In this way, a semantic model used to build targeted search advertising campaigns can also include elements of an ontology (and/or a taxonomy) in the sense that the possible attributes of classified concepts can also be specified as can the relationships between those attributes. In several embodiments, a semantic model is constructed based upon keywords actually used by people searching for the specific products and/or services that are featured in an advertising campaign. In many embodiments, the semantic model is used to relate landing pages within a website or group of websites to categories and attributes. The semantic model can also be used to identify relationships between keyword components and the categories and attributes within the semantic model and these relationships used to identify potentially relevant keywords for use in targeting a search advertising campaign with respect to specific concepts defined by the categories and attributes within the semantic model. In a number of embodiments, a set of products and/or services (i.e. concepts) advertised via one or more websites along with a list of keywords relevant to the products and/or services are processed to generate a semantic model. In a number of embodiments, the possible keywords include known keywords and keywords generated by combining keyword components from known keywords using known grammar patterns. The set of possible keywords is often referred to as the keyword space. In several embodiments, the semantic model maps the keywords in the keyword space to distinct concepts, and offer concepts can be identified within the semantic model that map to one or more creatives and one or more landing pages.

In targeted search advertising systems, bulksheets are commonly utilized in order to facilitate the management of campaign information provided to advertising server systems for use in one or more advertising campaigns. Bulksheets contain campaign information related to a particular search advertising campaign. In accordance with many embodiments, the search advertising campaign information in a bulksheet includes, but is not limited to, information such as keywords, advertisements, ad groups, and tracking uniform resource locators (URLs). Other campaign information not specifically listed above can be contained in bulksheets as appropriate to the requirements of specific applications in accordance with embodiments of the invention. By modifying a bulksheet associated with an advertising campaign, a user can easily expand a live advertising campaign related to a live advertising campaign and the bulksheet can be used to quickly and easily propagate the modified campaign to targeted advertising systems.

Systems and methods for expanding targeted search advertising campaigns while preserving live advertising campaign keywords and creatives in accordance with embodiments of the invention are discussed below.

### Targeted Advertising Systems

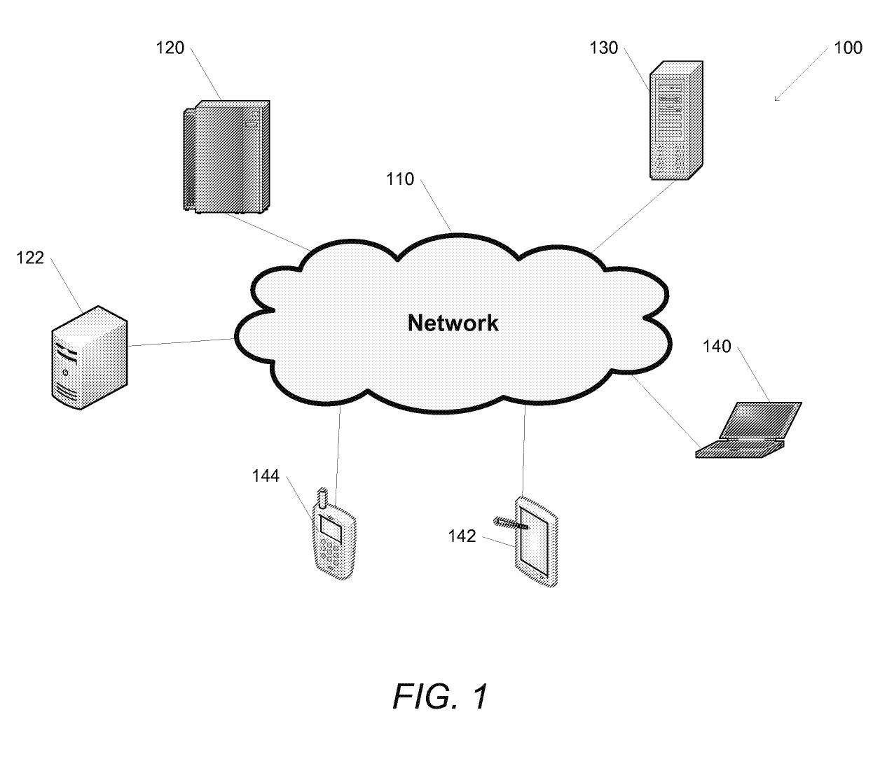

Targeted advertising systems are configured to deliver advertisements contained in or generated from advertising campaigns to user devices. Advertising systems utilized in search engine marketing are configured to deliver advertisements corresponding to the intent expressed in a search query. Targeted advertising systems in accordance with many embodiments of the invention are configured to create expanded advertising campaigns in order to better target advertisements to user devices based on the intent expressed in a search query. A diagram of a targeted advertising system in accordance with an embodiment of the invention is shown in FIG. 1. The system 100 includes a network 110 and an advertising server system 120, a search engine provider 122, a campaign expansion device 130, and user devices including computers 140, tablets 142, and phones 144 are configured to communicate via the network 110. In many embodiments, the campaign expansion device includes a processor and a memory connected to the processor and configured to store a variety of data and a campaign expansion application. In a number of embodiments, the campaign expansion application configures the processor to perform processes similar to those described below.

The campaign expansion device 130 automatically generates campaign information, including sets of ad groups which include, but are not limited to, taxonomies containing sets of creatives and sets of keywords, contained within targeted advertising campaigns for use in a search engine marketing campaign. In a variety of embodiments, the campaign expansion device 130 is configured to modify a live advertising campaign utilizing the campaign information. The campaign expansion device 130 uploads the campaign information to the advertising server system 120. In several embodiments, the advertising server system 120 is configured to presents the campaign information to the user devices 140, 142, and 144 as part of an advertising campaign. In many embodiments, the search engine provider 122 is configured to present one or more targeted advertisements to the user devices 140, 142, and 144 based on keywords in search queries provided by the user devices 140, 142, and 144. The search engine provider 122 can be configured to receive targeted advertising campaigns from the advertising server system 120 and present the targeted advertisements directly and/or present one or more keywords in the search terms along with the relevant user device to the advertising server system 120 and the advertising server system 120 presents the campaign information to the relevant user device based on the provided search terms. In a variety of embodiments, these advertisements are targeted toward the user devices based on a variety of factors, including, but not limited to, websites the user device has visited, the location of the user device, search terms provided by the user device, and the intent expressed in the provided search terms. In several embodiments, the campaign expansion device 130 is configured to measure the change in performance of the live advertising campaign based upon the modifications to the live advertising campaign.

In a number of embodiments, the network 110 is the Internet. In many embodiments, the campaign expansion device 130 is directly connected to the advertising server system 120. In several embodiments of the invention, the advertising server system 120 and/or the search engine provider utilizes bulksheets in order to manage advertising campaigns. In certain embodiments, the campaign expansion device 130 provides campaign information to the advertising server system 120 and/or the search engine provider 122 using bulksheets. In a number of embodiments, the user devices 140, 142, and 144 receive advertisements created using the campaign information from the advertising server system 120. Examples of advertisements received by user devices 140, 142, and 144 from an advertising server system 120 and/or a search engine provider 122 in accordance with embodiments of the invention include, but are not limited to, advertising presented along with results from a search query initiated by a user device and advertising presented when user devices visit an online social networking site.

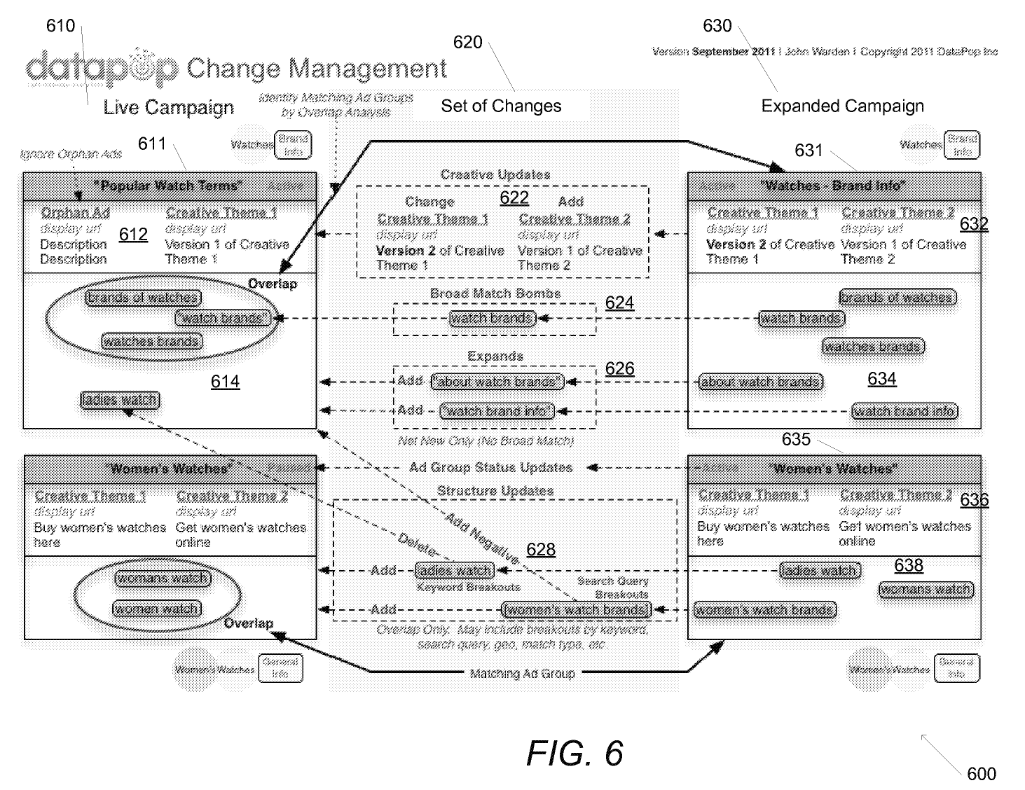

In accordance with many embodiments of the invention, the campaign expansion device 130 is configured to create expanded advertising campaigns based upon a live advertising campaign for a variety of reasons, including, but not limited to, better targeting user devices 140, 142, and 144. In a number of embodiments, the campaign expansion device 130 automatically generates a set of creatives that can be utilized to create the expanded advertising campaign. In several embodiments, the generated creatives include keywords that the campaign expansion device 130 had identified as relevant to the live advertising campaign and/or landing pages that the campaign expansion device 130 has identified as relevant for these keywords. A conceptual illustration of an expanded advertising campaign based upon a live advertising campaign targeting users searching for information concerning watches created by a campaign expansion device 130 in accordance with an embodiment of the invention is illustrated in FIG. 6. The example 600 includes a live advertising campaign 610, a set of changes 620, and an expanded advertising campaign 630. The live advertising campaign 610 has a first ad group 611, which includes two live creatives 612 and a set of keywords 614. The live advertising campaign 610 contains a first ad group 611 based upon “popular watch terms” with keywords 614 including “ladies watches,” “brands of watches,” “watch brands,” and “watches brands.” The live creatives 612 included an orphaned ad and a version of a creative theme 1.

In many embodiments, the set of changes 620 are automatically generated by the campaign expansion device 130 based upon the live creatives 612 and/or the set of keywords 614. The set of changes 620 includes expanded creatives 622, modified keywords 624, new keywords 626, and negative keywords 628. The campaign expansion device 130 determines the set of changes 620, updates the live creatives 612 to the expanded creatives 622, adding a new creative theme 2 and updating creative theme 1 to version 2. The campaign expansion device 130 can determine the set of changes 620 using an automated process and/or by manually modification. The set of changes 620 further adds two new keywords “about watch brands” and “watch brand info” and modifies the match type of “watch brands” to be a broad keyword. Furthermore, the term “ladies watch band” is deleted from the first ad group. The campaign expansion device 130 applies the set of changes 620 to the ad group 611 in the live advertising campaign results in a first expanded ad group 631 present in the expanded advertising campaign 630.

The expanded advertising campaign 630 includes two ad groups, the first expanded ad group 631 having a first set of updated creatives 632 and a first updated set of keywords 634, while the second expanded ad group 635 has a second set of updated creatives 636 and a second updated set of keywords 638. First expanded ad group 631 contains the expanded creatives 622 from the set of changes 620, and the first expanded ad group keywords 634 includes “brands of watches”, “watch brands,” “watches brands,” “about watch brands,” and “watch brand info,” which is the combination of the keywords 614 taken from the live ad group 611 and the additional keywords added 624, 626 in the set of changes 620. A specific expanded advertising campaign based upon an existing live advertising campaign and created by a campaign expansion device 130 is illustrated in FIG. 6, this example is provided by way of explanation only; any variety of live advertising campaigns, sets of changes, and/or expanded advertising campaigns can be utilized in accordance with embodiments of the invention.

In accordance with embodiments of the invention, the campaign expansion device 130 is configured to automatically determine one or more sets of changes and apply some or all of the determined changes to live advertising campaigns in order to create expanded advertising campaigns utilizing processes described below. In many embodiments, the sets of changes are determined and/or applied based on centroid clusters identified within the live advertising campaign. A variety of changes can be applied to the live advertising campaign, including modifying the keywords in the live campaign, modifying the creatives in the live campaign, updating landing pages, modifying the structure of the live campaign, and modifying ad groups in the live campaign. By creating an expanded advertising campaign from a live advertising campaign, a campaign expansion device 130 can measure the “uplift,” or the improvements in the performance of the expanded advertising campaign relative to the original live advertising campaign, attributable to the expanded advertising campaign.

Although a specific architecture of a targeted advertising system in accordance with embodiments of the invention are discussed above and illustrated in FIG. 1, a variety of architectures, including user devices not specifically named and other methods of serving targeted advertising campaign information, can be utilized in accordance with embodiments of the invention. Systems and methods for determining net-new keywords for an expanded bulksheet for use in targeted advertising systems are discussed below.

### Creating an Expanded Advertising Campaign

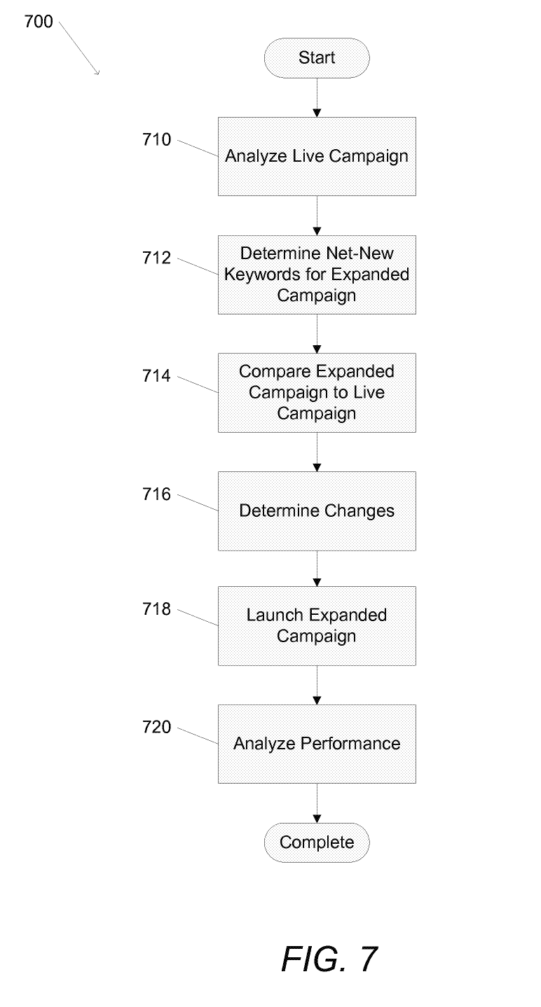

In order to improve the performance of an existing live advertising campaign, an expanded advertising campaign can be created based upon the live advertising campaign. In several embodiments, the process of expanding an advertising campaign includes selectively making changes to one or more keywords and/or creatives present in the live advertising campaign and measuring the impact of the changes. The selective changes allow for the incremental improvement of the live campaign while preserving optimizations related to specific keywords and/or creatives present in the live advertising campaign. The amount of improvement attributable to the expanded advertising campaign can be quantified based upon the modifications made to the live advertising campaign to create the expanded advertising campaign. A process for creating, deploying, and measuring the performance of an expanded advertising campaign is illustrated in FIG. 7. The process 700 includes analyzing (710) a live advertising campaign. Net-new keywords are determined (712) for an expanded advertising campaign. The expanded advertising campaign is compared (714) to the live advertising campaign. The changes to be integrated into the expanded advertising campaign are determined (716). The expanded campaign is launched (718) and the performance of the expanded campaign is analyzed (720).

In many embodiments, determining (712) net-new keywords includes modifying keywords and/or creatives present in the live advertising campaign and/or adding keywords and/or creatives not present in the live advertising campaign to the expanded advertising campaign. In a number of embodiments, processes similar to those described in U.S. patent application Ser. No. 13/424,373, incorporated by reference above, are used to generate the expanded advertising campaign. In a number of embodiments, the modified and/or new keywords and/or creatives are automatically generated based upon the live advertising campaign. In several embodiments, the modified and/or new keywords and creatives are generated utilizing a semantic model to determine if the modified and/or new keywords are relevant to the live advertising campaign. In several embodiments, the semantic model is generated based upon the live advertising campaign. The modified and/or new keywords and creatives can be generated to have a variable degree of overlap with the keywords and/or creatives present in the live campaign. In many embodiments, the overlap is minimized, although any degree of overlap can be utilized in accordance with the requirements of a variety of embodiments of the invention.

In several embodiments, comparing (714) the expanded advertising to the live advertising campaign includes, but is not limited to, analyzing the differences in keywords, match types, and creatives in the advertising campaigns and estimations of the number of impressions affected by each possible difference. In several embodiments, comparing (714) the expanded advertising campaign and the live advertising campaign can be performed side-by-side. Determining (716) the changes to be used in the expanded advertising campaign can be performed manually and/or automated in a variety of ways, such as implementing changes based upon the number of impressions affected, only applying changes of a particular type, and/or other advertising metrics. In accordance with many embodiments of the invention, types of changes include, but are not limited to, expanded keywords, creative updates, ad group status changes, creative changes, and ad campaign structure updates. In several embodiments, the performance of a campaign can be analyzed (720) using, but not limited to, the click-through rate of creatives, the number of hits the campaign receives, and overlap targets.

Although a specific process for creating, launching, and analyzing the performance of an expanded advertising campaign in accordance with an embodiment of the invention is described above, a variety of processes can be utilized for expanding a campaign as appropriate to the requirements of specific applications in accordance with embodiments of the invention. Systems and methods for determining net-new keywords for use in expanded advertising campaigns in accordance with embodiments of the invention are described below.

### Determining Net-New Keywords for an Expanded Advertising Campaign

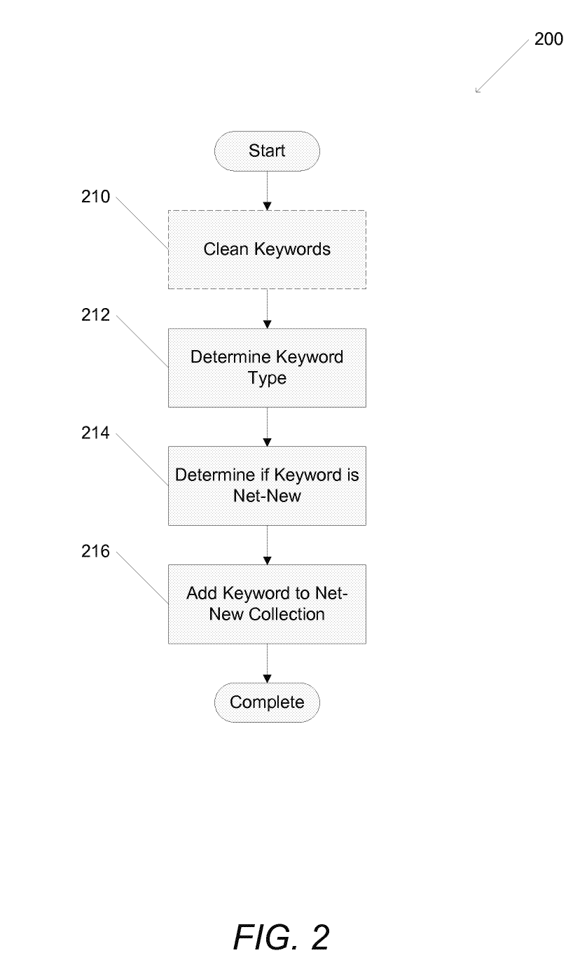

When creating an expanded advertising campaign from an existing live advertising campaign, it is desirable to add keywords not present in the live campaign and to modify the match type of keywords present in the live campaign in order to target additional advertising opportunities. In many embodiments, the keywords are taken from a set of creatives generated based upon the keywords utilized in the live campaign. The net-new keywords include the combination of additional and modified keywords. A process for determining net-new keywords relative to a live advertising campaign in accordance with an embodiment of the invention is illustrated in FIG. 2. In many embodiments, the process 200 includes cleaning (210) a set of keywords in a set of creatives. For each keyword in the set of creatives, the match type of the keyword is determined (212). A determination (214) is made if the keyword is a net-new keyword with regard to the live advertising campaign. If the determination (214) is that the keyword is not present in the live campaign (hence is a net-new keyword), the keyword is added (216) to a collection of net-new keywords for inclusion in the expanded advertising campaign.

In a number of embodiments, cleaning (210) keywords involves filtering stop words from the set of keywords in the generated set of creatives. In several embodiments, determining (214) if a keyword is present in a set of keywords in a live campaign involves comparing the match type of the keywords being compared. In many embodiments of the invention, match types include exact, phrase, and broad. In a number of embodiments, keywords can include negative keywords and match types further include negative matches. Additionally, keywords with a particular match type are often known as ‘match type’ keywords. For example, a keyword with a phrase match type is often called a phrase keyword. The same keyword can be present in both the live advertising campaign and the expanded advertising campaign with different match types; the variation in match type will result in the keyword being determined (214) as being a net-new keyword to be added (216) to the expanded advertising campaign. In a variety of embodiments, a net-new keyword is a keyword that has little or no overlap with any traffic currently generated by the keywords in the live advertising campaign. In a number of embodiments, it is preferable to add exact keywords and/or phrase keywords as part of an expanded advertising campaign instead of broad keywords for a variety of reasons, including, but not limited to, measuring the change in performance of the expanded advertising campaign relative to the live advertising campaign due to the additional keywords.

Although a specific process for determining keywords for inclusion in an expanded bulksheet in accordance with and embodiment of the invention is discussed above, a variety of processes, including processes utilizing different keyword cleaning techniques and alternative processes for matching keywords, can be utilized in accordance with embodiments of the invention. Processes for determining net-new keywords using the match type of the keywords in accordance with embodiments of the invention are described below.

### Determining Net-New Exact Keywords

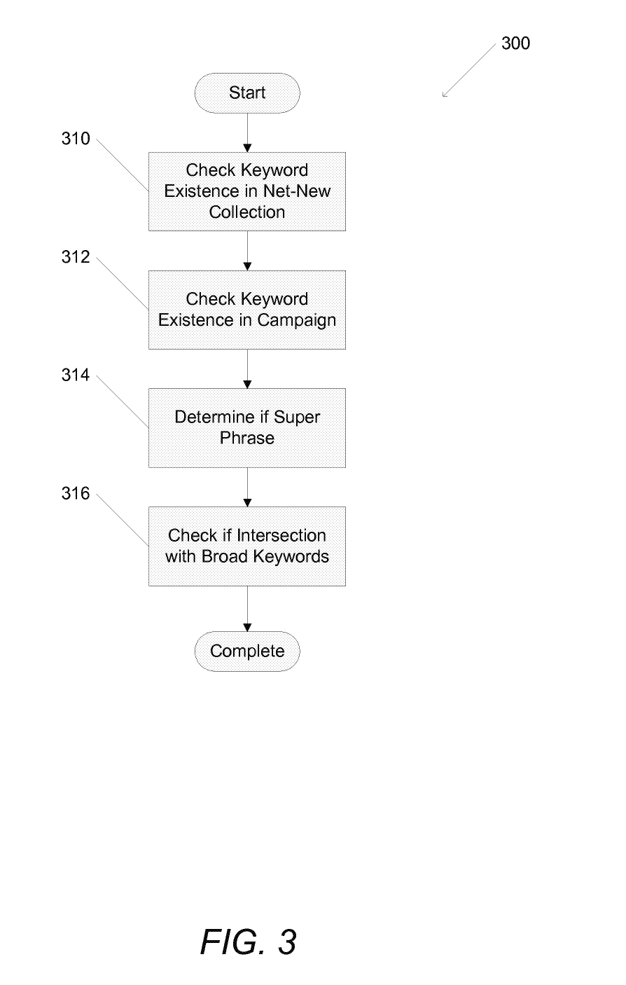

One type of keyword utilized in targeted advertising campaigns in accordance with embodiments of the invention is exact keywords. An exact keyword is matched when a search term exactly matches or is a close variant of the keyword. By adding exact keywords to a live advertising campaign, an expanded advertising can demonstrate improved targeting to particular search terms. A process for determining net-new exact keywords for use in an expanded advertising campaign in accordance with an embodiment of the invention is illustrated in FIG. 3. The process 300 includes checking (310) the existence of an exact keyword in a net-new keyword collection. The existence of the exact keyword in the existing live advertising campaign is checked (312). It is then determined (314) if the exact keyword is a super phrase of any keyword having a phrase match type in the live advertising campaign. In accordance with embodiments of the invention, a super phrase is a keyword that includes another keyword. The exact keyword is checked (316) to determine if there exists an intersection between the exact keyword and any word (or token) in any broad match keywords in the live advertising campaign. If the answers to steps (310)-(316) are all in the negative, then the exact keyword is a net-new exact keyword that can be added to the net-new keyword collection and utilized in the expanded advertising campaign.

In a variety of embodiments, it is desirable to maintain particular keywords in the live campaign due to the performance of the keyword. In several embodiments, it is desirable to add or modify keywords to the live campaign in order to drive additional traffic to the keywords in the live campaign and/or the expanded campaign. In many embodiments, checking (310) the existence of the exact keyword in the net-new collection and/or checking (312) the existence of the exact keyword in the live advertising campaign involves determining if the exact keyword exists with any match type. In several embodiments, if the exact keyword exists in the live advertising campaign, the exact keyword can be copied to the expanded advertising campaign without being added to the net-new keywords collection. In a number of embodiments, if the exact keyword exists in the live advertising campaign with a different match type, the exact keywords can be added to the net-new keywords collection as an exact keyword.

Although a specific process for determining net-new exact keywords in accordance with an embodiment of the invention is discussed above, a variety of processes can be utilized to determine net-new exact keywords in accordance with embodiments of the invention. A process for determining net-new phrase keywords in accordance with an embodiment of the invention is described below.

### Determining Net-New Phrase Keywords

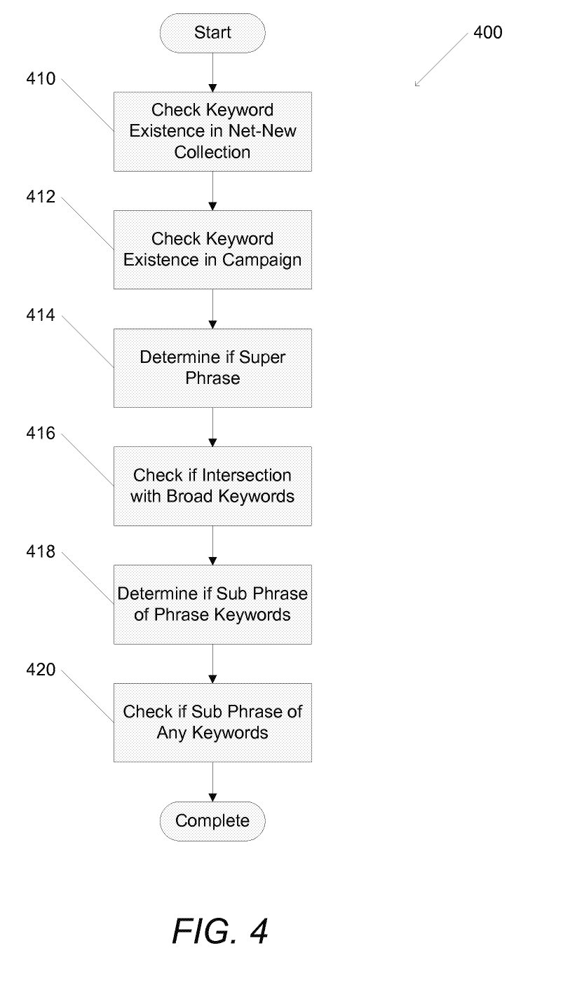

A second type of keyword utilized in targeted advertising campaigns in accordance with embodiments of the invention is phrase keywords. A phrase keyword is matched when a phase in a search term matches the phrase keyword or a close variant of the phrase keyword. In a variety of embodiments, phrase keywords can be added in an expanded advertising campaign to better target phrases present in search queries that the expanded advertising campaign is targeted towards. A process for determining net-new phrase keywords for use in an expanded advertising campaign in accordance with an embodiment of the invention is illustrated in FIG. 4. The process 400 includes checking (410) if a phrase keyword exists in a net-new keyword collection, checking (412) if the phrase keyword exists in a live advertising campaign, determining (414) if the phrase keyword is a super phrase of any phrase keyword in the live advertising campaign, and checking (416) if the phrase keyword intersects with any broad keywords in the live advertising campaign. A determination (418) is made if the phrase keyword is a sub-phrase of any phrase keyword in the live advertising campaign. In accordance with embodiments of the invention, a sub-phrase is a keyword that is a portion of another keyword. The phrase keyword is checked (420) if it is a sub-phrase of any existing keyword in the live advertising campaign. If the answer to steps (410), (412), (414), (416), (418), and (420) is in the negative, the phrase keyword is added to the net-new keyword collection to be utilized in the expanded advertising campaign. If the answer to step (420) is yes, the keyword is added as an exact keyword to the net-new keyword collection. In accordance with embodiments of the invention, a process similar to the process described above with respect to FIG. 3 can be utilized for steps (410), (412), (414), and (416).

Although a specific process for determining net-new phrase keywords in accordance with an embodiment of the invention is described above, a variety of processes, including those which do not add phrase keywords as exact net-new keywords when the phrase keyword is a sub-phrase of any keyword in a live advertising campaign, can be utilized in accordance with embodiments of the invention. A process for determining net-new broad keywords in accordance with an embodiment of the invention is described below.

### Determining Net-New Broad Keywords

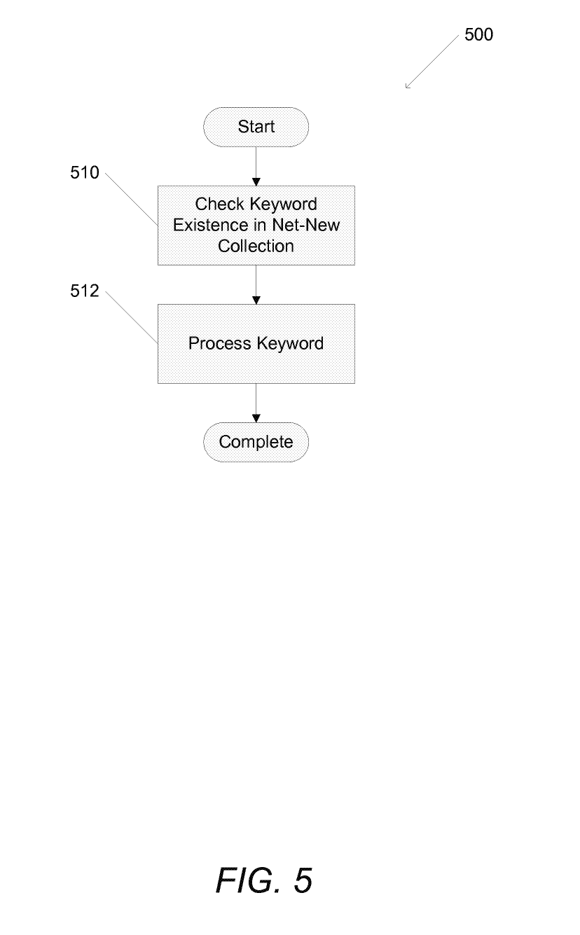

A third type of keyword utilized in targeted advertising campaigns in accordance with embodiments of the invention is broad keywords. A broad keyword is matched when a search term matches the keyword, a synonym for the keyword, and/or other related variations of the keyword. By adding broad keywords, an expanded advertising campaign can more expansively target additional keywords and phrases relative to the original live advertising campaign. A process for determining net-new broad keywords for use in an expanded advertising campaign in accordance with an embodiment of the invention is illustrated in FIG. 5. The process 500 includes checking (510) if a broad keyword exists in a net-new keyword collection. If the broad keyword does not exist in the net-new keyword collection, the broad keyword is processed (512). In accordance with embodiments of the invention, broad keywords can only be added to a net-new keyword collection for use in an expanded advertising campaign as a keyword with a match type of phrase or exact. In many embodiments of the invention, a broad keyword is processed (512) as a phrase keyword utilizing a process for determining phrase keywords. In several embodiments, the process described above with respect to FIG. 4 can be utilized to process (512) broad keywords.

A specific process for determining net-new broad keywords in accordance with an embodiment of the invention is described above; however, a variety of processes, including those which treat broad keywords as keywords with a match type which is not phrase or exact and processes which add broad keywords to net-new keyword collections, can be utilized in accordance with embodiments of the invention. Processes for modifying advertising campaigns based on centroid clusters in accordance with embodiments of the invention are discussed below.

### Expanding Live Advertising Campaigns Using Centroid Clusters

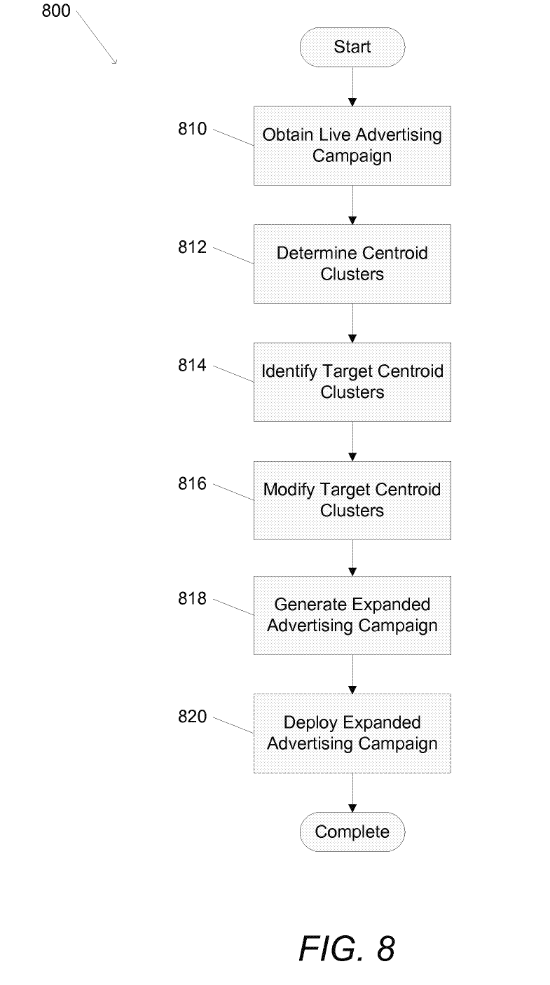

Live targeted advertising campaigns encompass a variety of keywords and/or creatives that can be conceptually clustered into one or more centroid clusters based on the relationships between the keywords and/or creatives. Many live advertising campaigns contain one or more centroid clusters associated with keywords and/or creatives that could exhibit improved performance in the targeted advertising campaign. Campaign expansion devices are configured to identify centroid clusters within a live advertising campaign, expand the keywords and/or creatives associated with one or more of the centroid clusters, and generate an expanded advertising campaign based on the expanded centroid clusters. A process for expanding a live advertising campaign using centroid clusters is conceptually illustrated in FIG. 8. The process 800 includes obtaining (810) a live advertising campaign. Centroid clusters are determined (812). Target centroid clusters are identified (814) and modified (816). An expanded advertising campaign is generated (818). In a variety of embodiments, the expanded advertising campaign is deployed (820).

A live advertising campaign can be obtained (810) from an advertising server system, a search engine provider, and/or any other source as appropriate to the requirements of specific applications in accordance with embodiments of the invention. In many embodiments, determining (812) centroid clusters includes identifying keywords and/or creatives that are conceptually related. In several embodiments, the relatedness of keywords and/or creatives is determined using consumer intent associated with the keywords and/or creatives. In a number of embodiments, conceptual relationships between keywords and/or creatives are determined using a semantic model. In several embodiments, the relatedness of keywords and/or creatives is measured as the distance between the keywords and/or creatives associated with the semantic model and the determination (812) of keywords and/or creatives associated with a centroid cluster includes determining when the distance between the keywords and/or creatives is within a threshold value. This threshold value can be determined dynamically and/or pre-defined. In a variety of embodiments, the relatedness of keywords and/or creatives is determined using the match types associated with the keywords and/or creatives. In many embodiments, keywords and/or creatives are associated with a centroid cluster based on the performance of the keywords and/or creatives. In a variety of embodiments, the keywords and/or creatives associated with a centroid cluster are hand-tuned. In many embodiments, one or more keywords and/or creatives are not in any determined (812) centroid cluster and are then associated with a miscellaneous centroid cluster. In several embodiments, the miscellaneous centroid cluster is included in the generated (818) expanded advertising campaign without being modified (816), excluded from the generated (818) expanded advertising campaign, and/or treated as any other centroid cluster as appropriate to the requirements of specific applications in accordance with embodiments of the invention.

In many embodiments, determining (812) a centroid cluster includes characterizing the keywords and/or concepts based on token characteristic metadata of search terms associated with the keywords and/or concepts. Token characteristic metadata for one or more search terms associated with keywords and/or concepts include determining the number of times each search term is associated with a click-through and/or an impression count; other techniques for determining token characteristic metadata for a search term can be utilized as appropriate to the requirements of specific applications in accordance with embodiments of the invention. The keywords and/or concepts and associated token characteristic metadata are processed to identify one or more topic models within the keywords and/or concepts based on the associated token characteristic metadata. In a variety of embodiments, one or more topic modeling techniques and/or models, such as Latent Dirichlet Allocation, Pachinko Allocation, Latent Semantic Indexing, Non-Negative Matrix Factorization, Probabilistic Latent Semantic Indexing, and/or Independent Component Analysis, are utilized to identify the topic models. Other topic modeling techniques can be utilized as appropriate to the requirements of specific applications in accordance with embodiments of the invention. In several embodiments, the number of topic models determined is provided as part of the topic modeling process based on the expected number of topics to be generated; the number of topics can also be determined dynamically. In a number of embodiments, the keywords and/or concepts, associated token characteristic metadata, and identified topic models are clustered to determine (812) centroid clusters within the keywords and/or concepts. In many embodiments, the clustering technique is a hierarchical clustering technique allowing for multiple levels of granularity in the determination (812) of centroid clusters, although any clustering techniques can be utilized as appropriate to the requirements of specific applications in accordance with embodiments of the invention.

In a variety of embodiments, determining (812) a centroid cluster includes determining semantic search terms by processing the search terms associated with the keywords and/or concepts using a semantic model. In several embodiments, the semantic model is related to the live advertising campaign; unrelated semantic models can be utilized as appropriate to the requirements of specific applications in accordance with embodiments of the invention. Token characteristic metadata associated with the keywords and/or concepts is determined based on the semantic search terms. In a number of embodiments, the token characteristic metadata describes how many times one or more of the semantic search terms is associated with the keywords and/or concepts and the number of click-throughs and/or impression counts associated with the semantic search terms. Semantic topic models are generated using one or more of the topic modeling techniques described above with respect to the token characteristic metadata, the keywords and/or concepts, and the semantic search terms. The keywords and/or concepts, associated token characteristic metadata, and identified semantic topic models are clustered to determine (812) centroid clusters within the keywords and/or concepts. Any clustering techniques, including those described above, can be utilized as appropriate to the requirements of specific applications in accordance with embodiments of the invention.

In several embodiments, centroid cluster density is utilized to identify (814) target centroid clusters. In a number of embodiments, a determined (812) centroid cluster has centroid cluster metadata describing the density of the centroid cluster. In many embodiments, the density of a centroid cluster is calculated using the weight of the centroid cluster and the semantic area of the centroid cluster. In a variety of embodiments, the weight of a centroid cluster is based on (aggregated) performance data such as impression counts, click-through rates, conversion rates, costs, generated revenue, and/or the search volume associated with the some or all of the keywords and/or concepts associated with the centroid cluster. Other factors can be utilized to determine the weight of a centroid cluster as appropriate to the requirements of specific applications in accordance with embodiments of the invention. In several embodiments, the semantic area of a centroid cluster is determined based on the relationships between the keywords and/or concepts associated with the centroid cluster. In a number of embodiments, the relationships between the keywords and/or concepts associated with the centroid cluster are determined based on the semantic distance between the keywords and/or concepts in a semantic model. In many embodiments, the semantic distance between the keywords and/or concepts in a semantic model is determined based on the number of relatives between the keywords and/or concepts within the semantic model. In a variety of embodiments, the relationship between elements within a semantic model can be represented as a set of nodes and weighted edges; accordingly, the distance between keywords and/or concepts within the semantic model is a weighted score based on the nodes and edges between the keywords and/or concepts. In several embodiments, the relatedness of keywords and/or concepts within a centroid cluster is determined based on the orientation distance between the keywords and/or concepts. In a number of embodiments, the orientation distance between keywords and/or concepts is determined based on the number of attributes that match between the keywords and/or concepts and the number of attributes that differ between the keywords and/or concepts. In several embodiments, if the keywords and/or concepts have no common attributes, the orientation distance between the keywords and/or concepts is infinite and if all the attributes between the keywords and/or concepts match the orientation distance is zero. In a variety of embodiments, the semantic area of a centroid cluster is a (weighted) function of the semantic distance of the attributes and attribute/value pairs between the keywords and/or concepts and the orientation distance between the keywords/and or concepts associated with the centroid cluster. In several embodiments, the orientation distance is weighted more heavily (for example, 10×) than the distance between the attributes. In a number of embodiments, category-related attributes are weighted more heavily (for example, 8×) than non-category related attributes. In a variety of embodiments, scaling the weights associated with the semantic area of a centroid cluster is utilized to generate centroid clusters with varying densities based on the aggregated performance weight of the centroid cluster. In many embodiments, a representative keyword and/or concept can be associated with the centroid cluster based on the semantic area of the centroid cluster and the match type associated with the keyword and/or concept. Based on the representative keyword and/or the semantic area of the centroid cluster, consumer intent associated with the keywords and/or concepts associated with the centroid cluster can be identified.

In a number of embodiments, target centroid clusters are identified (814) based on the performance of the keywords and/or creatives associated with the centroid cluster. The performance of a keyword and/or creative can be determined based upon a variety of factors, including impression counts, click-through rates, conversion rates, costs, generated revenue, and search volume. Other factors can be utilized to determine the performance of a keyword and/or creative as appropriate to the requirements of specific applications in accordance with embodiments of the invention. In many embodiments, identifying (814) target centroid clusters is based on the match type of the keywords and/or creatives associated with the centroid cluster. In a variety of embodiments, identifying (814) target centroid clusters is based on the intent associated with the keywords and/or creatives associated with the centroid cluster. In several embodiments, identifying (814) target centroid clusters includes identifying the best performing centroid cluster(s). In a number of embodiments, the best performing centroid clusters are excluded from being modified (816).

In many embodiments, one or more of the identified (814) target centroid clusters are modified (816) utilizing processes similar to those described above. In a variety of embodiments, the generated (818) expanded advertising campaign includes the original live advertising campaign with the modified (816) centroid clusters replacing the corresponding centroid clusters determined (812) using the live advertising campaign. In several embodiments, deploying (820) the expanded advertising campaign includes generating a bulksheet and transmitting the bulksheet to an advertising server system and/or a search engine provider.

A specific process for generating an expanded advertising campaign utilizing centroid clusters identified within a live advertising campaign is described above with respect to FIG. 8; however, a variety of processes, including those which cluster keywords and/or concepts utilizing processes other than those described above, can be utilized in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A campaign expansion device, comprising:
a processor; and
a memory connected to the processor and configured to store a campaign expansion application;
wherein the campaign expansion application configures the processor to:
obtain a live advertising campaign, where the live advertising campaign comprises a plurality of keywords and match types associated with the keywords;
determine at least one centroid cluster including a portion of the plurality of keywords in the live advertising campaign, where the included portion of the plurality of keywords in a centroid cluster are related;
identify at least one target centroid cluster in the at least one centroid cluster;
modify at least one match type associated with at least keyword within each of the identified target centroid clusters; and
generate an expanded advertising campaign, where the extended advertising campaign includes the unmodified portion of the plurality of keywords and match types associated with the keywords from the live advertising campaign and the modified keywords and associated match types.

2. The system of claim 1, wherein the campaign expansion application further configures the processor to deploy the expanded advertising campaign to a device selected from the group consisting of an advertising server system and a search engine provider.

3. The system of claim 1, wherein the campaign expansion application further configures the processor to add at least one keyword having an associated match type to at least one of the identified centroid clusters.

4. The system of claim 3, wherein the added keyword has a match type selected from the group consisting of an exact match type and a phrase match type.

5. The system of claim 1, wherein the campaign expansion application further configures the processor to identify keywords as related using a semantic model, where the semantic model comprises a set of relationships between keywords and concepts defined by categories and attributes.

6. The system of claim 5, wherein the campaign expansion application further configures the processor to identify keywords as related based on the distance between the keywords within the semantic model.

7. The system of claim 1, wherein the campaign expansion application further configures the processor to identify keywords as related based on the match types associated with the keywords.

8. The system of claim 1, wherein the campaign expansion application further configures the processor to identify at least one target centroid cluster based on the performance of the keywords associated with the target centroid cluster.

9. The system of claim 8, wherein the campaign expansion application further configures the processor to:
determine the identified target centroid cluster with the highest performance; and
exclude the identified target centroid cluster with the highest performance from being modified.

10. The system of claim 1, wherein the campaign expansion application further configures the processor to:
identify a portion of the keywords in the live advertising campaign that are not associated with a centroid cluster;
create a miscellaneous centroid cluster including the portion of the keywords in the live advertising campaign that are not associated with a centroid cluster; and
include the miscellaneous centroid cluster in the extended advertising campaign.

11. A method for creating an expanded advertising campaign, comprising:
obtaining a live advertising campaign using a campaign expansion device, where the live advertising campaign comprises a plurality of keywords and match types associated with the keywords;
determining at least one centroid cluster including a portion of the plurality of keywords in the live advertising campaign using the campaign expansion device, where the included portion of the plurality of keywords in a centroid cluster are related;
identifying at least one target centroid cluster in the at least one centroid cluster using the campaign expansion device;
modifying at least one match type associated with at least keyword within each of the identified target centroid clusters using the campaign expansion device; and
generating an expanded advertising campaign using the campaign expansion device, where the extended advertising campaign includes the unmodified portion of the plurality of keywords and match types associated with the keywords from the live advertising campaign and the modified keywords and associated match types.

12. The method of claim 11, further comprising deploying the expanded advertising campaign to a device using the campaign expansion device, where the device is selected from the group consisting of an advertising server system and a search engine provider.

13. The method of claim 11, further comprising adding at least one keyword having an associated match type to at least one of the identified centroid clusters using the campaign expansion device.

14. The method of claim 13, wherein the added keyword has a match type selected from the group consisting of an exact match type and a phrase match type.

15. The method of claim 11, further comprising identifying keywords as related based on semantic model using the campaign expansion device, where the semantic model comprises a set of relationships between keywords and concepts defined by categories and attributes.

16. The method of claim 15, further comprising identifying keywords as related based on the distance between the keywords within the semantic model using the campaign expansion device.

17. The method of claim 11, further comprising identifying keywords as related based on the match types associated with the keywords using the campaign expansion device.

18. The method of claim 11, further comprising identifying at least one target centroid cluster based on the performance of the keywords associated with the target centroid cluster using the campaign expansion device.

19. The method of claim 18, further comprising:
determining the identified target centroid cluster with the highest performance using the campaign expansion device; and
excluding the identified target centroid cluster with the highest performance from being modified using the campaign expansion device.

20. The method of claim 11, further comprising:
identifying a portion of the keywords in the live advertising campaign that are not associated with a centroid cluster using the campaign expansion device;
creating a miscellaneous centroid cluster including the portion of the keywords in the live advertising campaign that are not associated with a centroid cluster using the campaign expansion device; and
including the miscellaneous centroid cluster in the extended advertising campaign using the campaign expansion device.
